(19) United States
(12) Patent Application Publication
(10) Pub. No.: US 2019/0052774 A1
(43) Pub. Date: Feb. 14, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Hiroyuki Oka, Kashiwa-shi (JP)

(21) Appl. No.: 16/058,825

(22) Filed: Aug. 8, 2018

(30) Foreign Application Priority Data
Aug. 10, 2017 (JP) 2017-155447

(51) Int. Cl. H04N 1/60; G06K 15/02

(52) U.S. Cl. CPC H04N 1/6072; H04N 1/603; G06K 15/1878; G06K 15/1822

(57) ABSTRACT

An image processing apparatus includes an acquisition unit that acquires information about a color space specified for an object to be processed by interpreting input image data, and a determination unit that determines whether a first color conversion or a second color conversion is used by using the information acquired by the acquisition unit. The first color conversion is used for converting only a color to be processed into a color in a device-dependent color space. The second color conversion is used for converting the color to be processed and the color having a different density into a color in the device-dependent color space.

### BACKGROUND

### Field of the Disclosure

The present disclosure relates to an image processing apparatus and an image processing method, and more particularly, to a method for converting a color rendering command into a density value of a color material that is dependent on an image forming apparatus (printer).

### Description of the Related Art

A page description language (hereinafter referred to as PDL) is used as a format of data to be input to a printer. In the PDL, as a method for specifying colors, a color space is usually specified using Gray (one component of brightness), RGB (three brightness components of red, green, and blue), CMYK (four density components of cyan, magenta, yellow, and key (black)), or the like. Such colors are made when the data is created according to a color gamut (hereinafter referred to as a first color gamut) that can be output by a liquid crystal display, a scanner, a camera, or the like. In a case where such an image is printed using a device such as a printer that has a color gamut (hereinafter referred to as a second color gamut) different from the first color gamut from a scanner, a camera, and the like, it is necessary to adjust output values of color materials so that the image can be printed in colors as close as possible to the colors in the first color gamut. Accordingly, there is a system for adjusting colors based on the CIE colorimetric system, which is a device-independent color space, by using IccProfile, which is a format defined by the International Color Consortium. This system is called color management. Examples of color spaces in the CIE colorimetric system include CIEXYZ and CIELAB.

As a color specification method using the PDL, in addition to Gray, RGB, and CMYK, a method of specifying a color name as a special color space is known. For example, printing may be performed by using a special color ink called “SpecialGreen” as a fifth color screen in addition to basic process colors of cyan, magenta, yellow, and black. In this case, the color name “SpecialGreen” is specified for the color space in PDL data. In a case of performing test printing of the PDL data using a simple printer that uses only basic process colors of ink and does not use the special color ink called “SpecialGreen”, the data cannot be printed using a “SpecialGreen” command. It is necessary to convert the “SpecialGreen” into density values of process colors of ink, which are mounted on the printer and can reproduce a color that is close to the original “SpecialGreen”. As a color management system required for this conversion, NamedIccProfile is defined by the International Color Consortium. Values in a color space in the CIE colorimetric system corresponding to the color name are described in the NamedIccProfile, and the values can be converted into values of the process colors (cyan, magenta, yellow, and black) of the printer using an output IccProfile of the printer. This conversion processing is referred to as special color simulation.

In a related art, in a case where a color name is specified for the color space in the PDL, on an assumption that a special color ink is specified, output values of the process colors corresponding to all color signal values are calculated in advance, and a calculation result is stored in a look-up table.

This is because in a PDL language structure, various color signal values can be generally specified using the color name. In addition, various color signal values are used as a use case of the special color ink. Calculation of the output values using the IccProfile for each of the colors takes a long calculation time. Accordingly, calculating the output values corresponding to various color signal values in advance prevents an increase in a processing time. However, since only the values corresponding to the color signal values of 100% are described in the NamedIccProfile, it is necessary to calculate the values corresponding to the color signal values other than 100%. A technique for achieving high-precision color management of the values corresponding to the color signal values other than 100% is discussed in Japanese Patent Application Laid-Open No. 2016-25496.

However, in a case where the color name is specified for the color space in the PDL, the color name may be specified using a spot color instead of the special color ink. The term spot color refers to a certain physical color expressed by a proper name of the color, and the color is generally defined in a color sample book. It is guaranteed that a printer outputs an image in colors that match colors in the color sample book. In the NamedIccProfile, a color value in the CIE colorimetric system corresponding to the color name is described just like in a dictionary. The color value in the CIE colorimetric system is converted into values of the process colors by using the output IccProfile of the printer, thereby achieving color printing in the spot color.

The spot color is basically used only in the color signal value of 100%. This is because a color represented by the color signal value other than 100% deviates from the color indicated in the color sample book. In printing for designing in which the spot color is specified for the color name, a large number of spot colors are used in one printed material. Accordingly, calculation of the process colors corresponding to various color signal values, like in the case of using the special color ink, requires an unnecessarily long calculation time and a vast amount of memory.

### SUMMARY

According to an aspect of the present disclosure, an image processing apparatus includes a memory device that stores a set of instructions, and at least one processor that executes the set of instructions to acquire information about a color space specified for an object to be processed by interpreting input image data, and determine, by using the acquired information, whether a first color conversion or a second color conversion is used, the first color conversion being used for converting only a color to be processed into a color in a device-dependent color space, the second color conversion being used for converting the color to be processed and the color having a different density into a color in the device-dependent color space.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of an image processing apparatus according to one or more aspects of the present disclosure.

FIG. 2 is a block diagram illustrating a hardware configuration of a host computer according to one or more aspects of the present disclosure.

FIG. 3 is a block diagram illustrating an internal configuration of an execution program to be executed by a central processing unit (CPU) according to one or more aspects of the present disclosure.

FIG. 4 illustrates an example of an application for generating PDL data according to one or more aspects of the present disclosure.

FIGS. 5A and 5B each illustrate an example of the PDL data according to one or more aspects of the present disclosure.

FIG. 6 is a block diagram illustrating a hardware configuration of a printer according to one or more aspects of the present disclosure.

FIG. 7 is a block diagram illustrating an internal configuration of an execution program of a CPU according to one or more aspects of the present disclosure.

FIGS. 8A, 8B, and 8C each illustrate an outline of processing to be performed by a color conversion data generation unit according to one or more aspects of the present disclosure.

FIG. 9 is a flowchart illustrating processing to be performed by the color conversion data generation unit according to one or more aspects of the present disclosure.

FIG. 10 is a flowchart illustrating processing to be performed by a color conversion unit according to one or more aspects of the present disclosure.

FIG. 11 is a block diagram illustrating an internal configuration of an execution program to be executed by the CPU according to one or more aspects of the present disclosure.

FIG. 12 is a flowchart illustrating processing to be performed by a color conversion data generation unit according to one or more aspects of the present disclosure.

FIG. 13 is a flowchart illustrating processing to be performed by a color conversion unit according to one or more aspects of the present disclosure.

### DESCRIPTION OF THE EMBODIMENTS

Exemplary embodiments for carrying out the present disclosure will be described below with reference to the drawings.

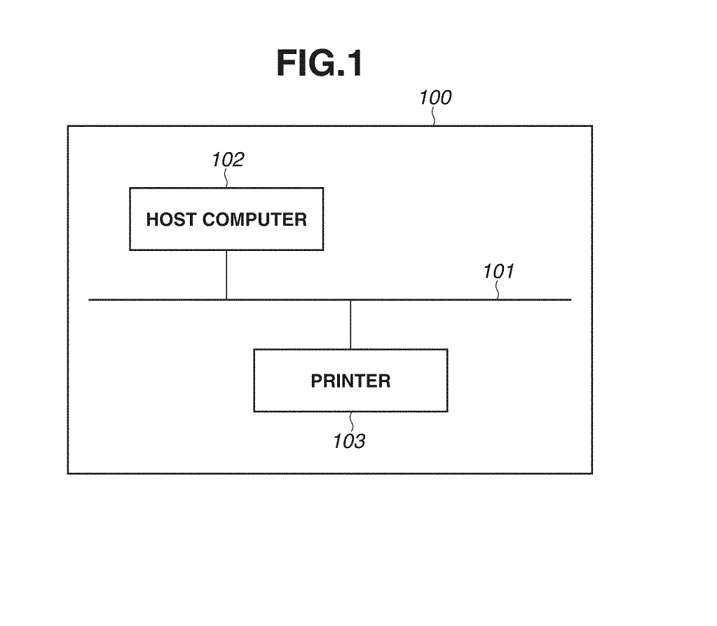

FIG. 1 illustrates a configuration example of an image processing system according to a first exemplary embodiment.

An image processing system 100 includes a data transmission path 101, a host computer 102, and a printer 103. The host computer 102 and the printer 103 are connected via the data transmission path 101, and thus can exchange data with each other. The host computer 102 receives an instruction from a user, generates PDL data according to the instruction from the user, and outputs the generated PDL data to the printer 103. The printer 103 receives the PDL data from the host computer 102, interprets the PDL data to generate a bitmap image, and performs image processing to convert the image into a screen image. A color material such as ink and toner is applied onto a surface of paper according to the screen image.

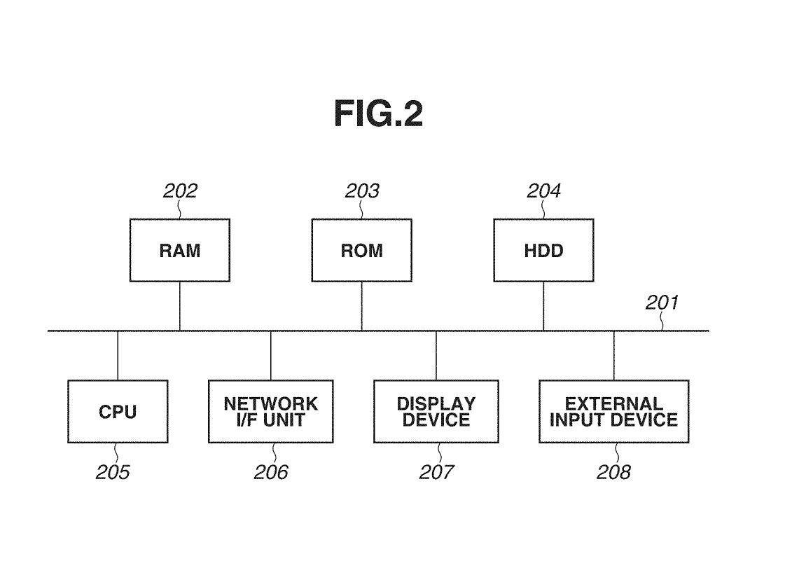

FIG. 2 is a block diagram illustrating a hardware configuration example of the host computer 102. The host computer 102 includes a data transmission path 201, a random access memory (RAM) 202, a read only memory (ROM) 203, a hard disk drive (HDD) 204, a central processing unit (CPU) 205, a network interface (I/F) unit 206, a display device 207, and an external input device 208. The RAM 202, the ROM 203, the HDD 204, CPU 205, the network I/F unit 206, the display device 207, and the external input device 208 are connected via the data transmission path 201, and thus can exchange data with each other. The CPU 205 sequentially loads programs such as an operating system and an application program stored in the ROM 203 or the HDD 204 into the RAM 202, and executes the programs. The CPU 205 displays a screen on the display device 207 according to the programs loaded into the RAM 202, and prompts the user to make an instruction. Then, the CPU 205 receives the instruction from the user through the external input device 208, thereby achieving communication with the user. According to the programs loaded into the RAM 202, the CPU 205 generates PDL data, stores the generated PDL data in the HDD 204, and outputs the PDL data to the printer 103 via the transmission path 101 using the network I/F 206.

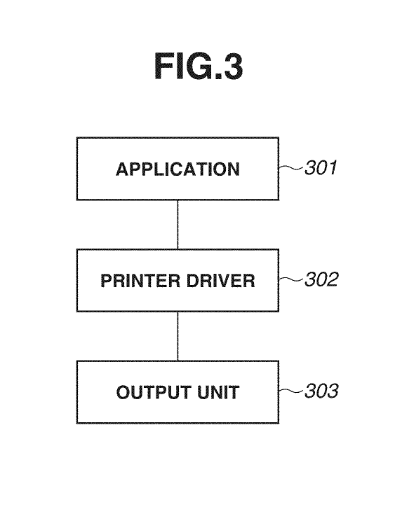

FIG. 3 illustrates a configuration example of an execution program associated with print processing of the host computer 102. Programs 301 to 303 are stored in the HDD 204, loaded into the RAM 202, and executed by the CPU 205. The application 301 receives, from the user, a rendering instruction and a color instruction of a text, a graphic, a photograph, and the like. The application 301 generates PDL data, and outputs the generated PDL data to the printer driver 302. The printer driver 302 instructs the output unit 303 to transmit the PDL data generated by the application 301 to the printer 103. The output unit 303 outputs the PDL data to the printer 103 using the network I/F unit 206.

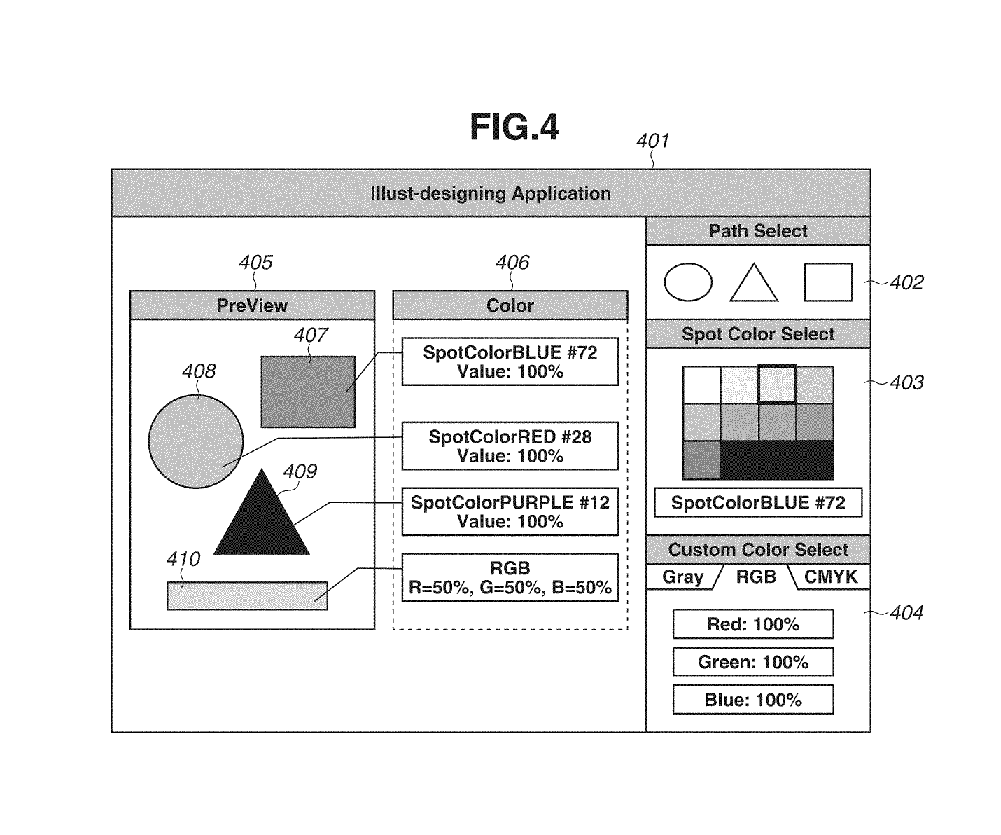

FIG. 4 illustrates an application screen 401, which is an example of a screen of the application 301 that generates the PDL data using the color name. The application 301 receives, from the user, selection of a graphic to be rendered on a PreView screen 405 by using a Path Select screen 402. Three types of graphics, i.e., a circle, a triangle, and a rectangle, can be specified on the Path Select screen 402. The application 301 also receives, from the user, selection of a spot color to be applied to the inside of the graphic by using a Spot Color Select screen 403. The application 301 also receives, from the user, selection of Gray, RGB, and CMYK colors to be applied to the inside of the graphic by using a Custom Color Select screen 404. Further, the application 301 displays, on a Color screen 406, information about the color having been applied to the inside of each of the graphics displayed on the PreView screen 405. In this example, a rectangle 407 is specified to be applied with “SpotColorBLUE #72” having a color signal value of 100%. A circle 408 is specified to be applied with “SpotColorRED #28” having a color signal value of 100%. A triangle 409 is specified to be applied with “SpotColorPURPLE #12” having a color signal value of 100%. In the case of using the spot color as the color name, a large number of spot colors each having a color signal value of 100% are used in one printing operation. Further, a rectangle 410 is specified to be applied with a color in an RGB color space.

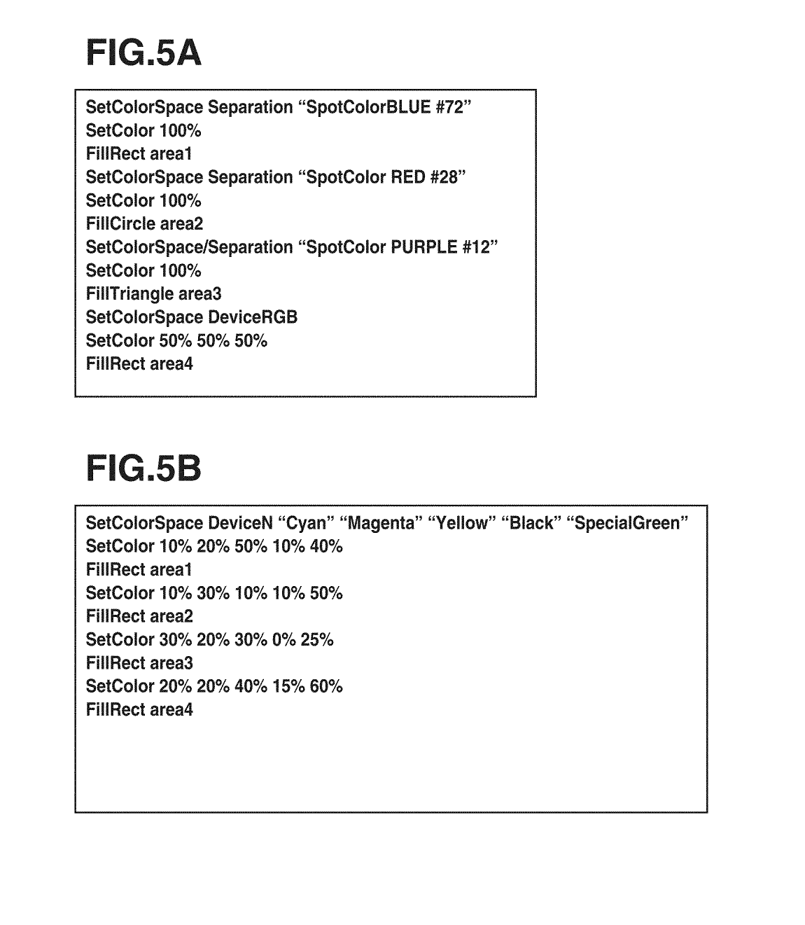

FIGS. 5A and 5B each illustrate an example of the PDL data generated by the application 301. FIG. 5A illustrates an example where rendering displayed on the PreView screen 405 illustrated in FIG. 4 is generated as the PDL data. As a command for setting a color space, “SetColorSpace” is defined in PDL, and the command receives specification of the color space as a parameter. For example, “Separation” is a PDL command for specifying one color screen and receives the color name as a parameter.

In FIG. 5A, the names of the spot colors displayed on the Color screen 406 illustrated in FIG. 4 are described as the color name.

As a command for specifying the color signal value, “SetColor” is defined in the PDL, and the color signal value can be specified in percentage terms from 0 to 100 as a parameter. Only the color signal value of 100% is specified for the spot color, and thus all the color signal values for the spot colors illustrated in FIG. 5A are 100%. Note that “FillRect”, “FillCircle”, and “FillTriangle” are commands for rendering a rectangle, a circle, and a triangle, respectively, and coordinate information about an area to be rendered is received as a parameter.

FIG. 5B illustrates an example of a PDL command in a case where a special color ink is used as the color name. The special color ink is commonly used when the number of color screens used in printing is five or more. As a command for specifying the color space, “DeviceN” is defined. The DeviceN indicates specification of a plurality of color screens, and a color for each of the screens can be specified as a parameter. In the example illustrated in FIG. 5B, the process colors such as cyan, magenta, yellow, and black are specified for first to fourth color screens, respectively, and the special color ink “SpecialGreen” is specified for a fifth color screen. In a SetColor command, five parameters are specified for the color signal values. The fifth parameter represents the color signal value of “SpecialGreen”. In a use case of the special color ink, not only the color signal value of 100% but also various color signal values are generally used as illustrated in FIG. 5B.

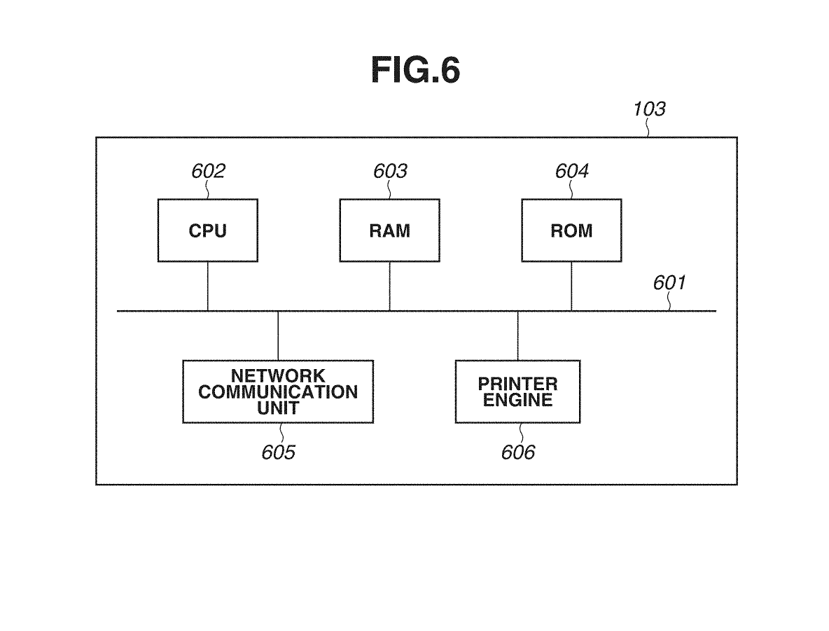

FIG. 6 is a block diagram illustrating a hardware configuration of the printer 103 according to the present exemplary embodiment. The printer 103 includes a data transmission bus 601, a CPU 602, a RAM 603, a ROM 604, a network communication unit 605, and a printer engine 606. The CPU 602, the RAM 603, the ROM 604, the network communication unit 605, and the printer engine 606 are connected via the data transmission bus 601, and thus can exchange data with each other. The ROM 604 stores a program for interpreting PDL data to generate a bitmap image, performing necessary image processing on the image, and then outputting a screen image signal to the printer engine 606. The CPU 602 loads the program into the RAM 603 from the ROM 604 and executes the program. The RAM 603 provides the CPU 602 with a work memory and an image buffer necessary for the CPU 602 to execute the program. The network communication unit 605 receives the PDL data output from the host computer 102 and transmits the PDL data to the CPU 602. The printer engine 606 receives, from the CPU 602, a signal value of a screen image constituted of a binary signal value of the process color (cyan, magenta, yellow, and black). Then, the printer engine 606 performs a pulse width modulation (PWM) control, scans a surface of a photosensitive body with laser to form a latent image on the photosensitive body, and applies and fixes a color material onto a paper medium, thereby forming an image on the paper medium.

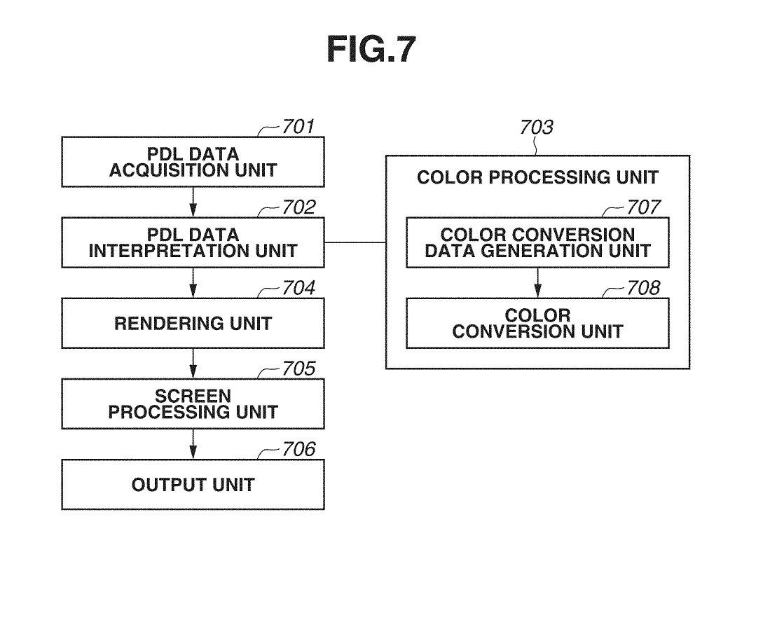

FIG. 7 is a block diagram illustrating an internal configuration of an execution program of the CPU 602 according to the present exemplary embodiment. The CPU 602 loads the program into the RAM 603 from the ROM 604 and executes the program. A PDL data acquisition unit 701 acquires the PDL data received by the network communication unit 605 from the host computer 102 via the data transmission path 101, and outputs the PDL data to a PDL data interpretation unit 702. The PDL data interpretation unit 702 interprets the PDL data, outputs the color signal value to be processed and specification of the color space corresponding to the color signal value to a color processing unit 703, and requests the color processing unit 703 to perform CMYK conversion. The color processing unit 703 includes a color conversion data generation unit 707 and a color conversion unit 708. The color processing unit 703 performs color matching based on the specification of the color space and the color signal value, converts the value into density signals (of colors in a device-dependent color space) of cyan, magenta, yellow, and black (CMYK) of the color material of the printer, and outputs the density signals to the PDL data interpretation unit 702. The PDL data interpretation unit 702 converts the color space and the color signal value into the output value of the process color acquired from the color processing unit 703, and outputs the output value together with an image rendering command to the rendering unit 704. The rendering unit 704 generates bitmap image data based on a rendering command for one page, and outputs the bitmap image data to the screen processing unit 705. The screen processing unit 705 converts the image data into a binary screen image signal of CMYK, and outputs the binary screen image signal to the data output unit 706. The data output unit 706 outputs the screen image signal to the printer engine 606, and the printer engine output unit 606 forms a toner image on the paper medium based on the screen image signal.

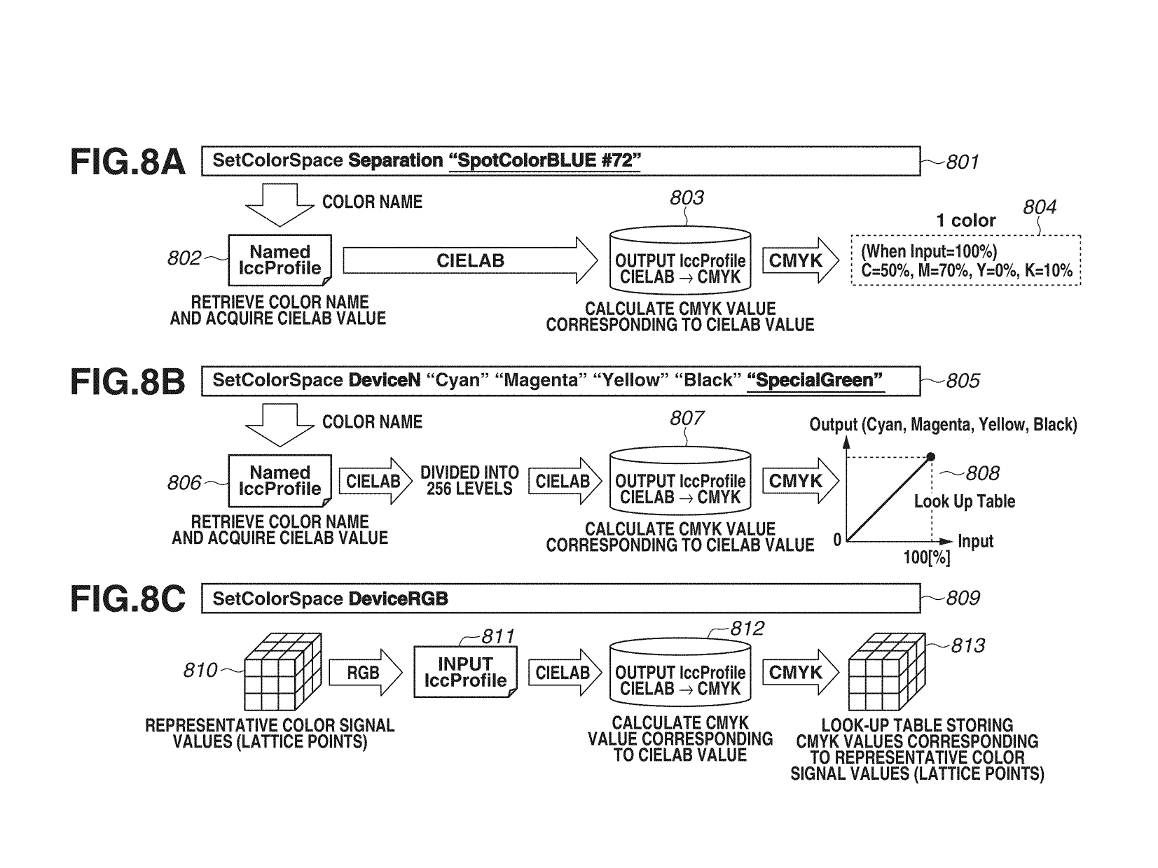

Next, an outline of processing performed by the CPU 602 in the color conversion data generation unit 707 will be described with reference to FIGS. 8A, 8B, and 8C.

FIG. 8A illustrates an example of processing to be performed in a case where the color name is specified using a Separation command 801. A NamedIccProfile 802 stores a CIELAB value corresponding to a color signal value of 100% of the color name. The CIELAB value is acquired by retrieving the color name from the NamedIccProfile 802. Then, an output IccProfile 803 is used for converting the CIELAB value into a CMYK value. The output IccProfile 803 stores a look-up table for converting the CIELAB value into the CMYK value, whereby the CIELAB value can be converted into the CMYK value. As a result, cyan 50%, magenta 70%, yellow 0%, and black 0% are obtained as the output value corresponding to the color signal value of 100%. The correspondence relationship between the color signal value and the output value is stored as color conversion data 804.

FIG. 8B illustrates an example of processing to be performed in a case where the special color ink is specified for the color name in the fifth color screen using a DeviceN command 805. A CIELAB value is acquired by retrieving the color name from the NamedIccProfile 806. In the case of FIG. 8B, the color name specifies the special color ink. Accordingly, the color signal value is not limited to the color signal value of 100%, and various color signal values are often used. Therefore, the CIELAB value acquired from the NamedIccProfile 806 is equally divided into 256 levels so as to respectively correspond to 8-bit color signal values of 0 to 255. Then, an output IccProfile 807 is used for calculating a CMYK value corresponding to each of the CIELAB values so that a 256-gradation look-up table 808 is generated.

FIG. 8C illustrates an example of processing to be performed in a case where a DeviceRGB command 809 indicating an RGB color space is specified in the PDL. Since the color name is not used, a CMYK value is calculated for each of representative color signal values (lattice points) 810 corresponding to some predetermined lattice points using an RGB input IccProfile 811 and an output IccProfile 812. A look-up table 813 is generated using this calculation result. The representative color signal values are used so as to prevent a considerable increase in a calculation amount and a memory amount due to a vast number of combinations of values obtained in a case where an output value is calculated for each of the color signal values for all combinations of RGB. However, the color signal values for all combinations may be calculated if possible.

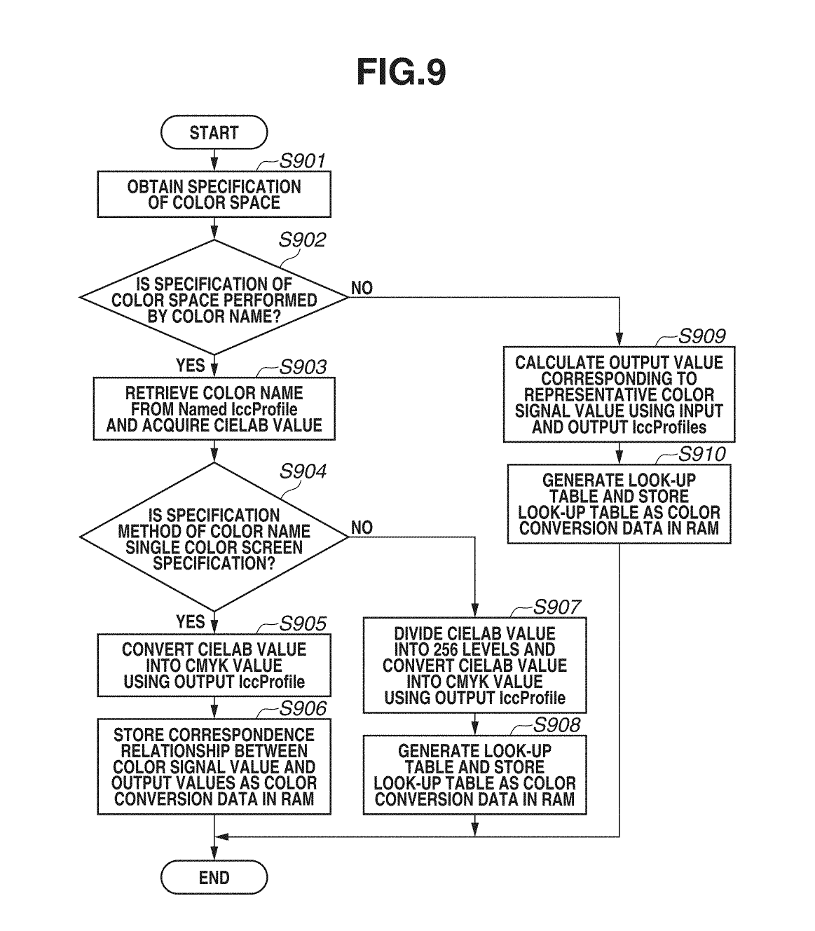

FIG. 9 is a flowchart illustrating processing to be performed by the color conversion data generation unit 707. First, in step S901, the CPU 602 obtains specification of a color space from the PDL data interpretation unit 702. Next, in step S902, the CPU 602 determines whether the specification of the color space is performed by the color name. If the specification of the color space is performed by the color name (YES in step S902), in step S903, the CPU 602 retrieves the color name from the NamedIccProfile and acquires a CIELAB value. In step S904, the CPU 602 determines whether a specification method of the color name is a single color screen specification command. Whether the command is the single color screen specification command may be determined based on whether the command is a type exclusively used for the single color screen specification (i.e., specification using a spot color) such as Separation. In a case where the method is a command capable of specifying a plurality of color screens (specification using the special color ink) such as DeviceN, it may be determined based on whether the number of color screens indicated by the parameter is one. If the specification method is the single color screen specification command (e.g., Separation illustrated in FIG. 8A) (YES in step S904), in step S905, the CIELAB value is converted into the CMYK value by using the output IccProfile, and in step S906, the correspondence relationship between the color signal value and the output value is stored as color conversion data in the RAM 603. If the specification method of the color name is not the single color screen specification command (e.g., a plurality of color screens is specified by DeviceN as illustrated in FIG. 8B) (NO in step S904), in step S907, first, the CIELAB value is divided into 256 levels, and next, the CIELAB value is converted into a CMYK value by using the output IccProfile. In step S908, a look-up table is generated and stored as color conversion data in the RAM 603. In step S902, if the specification of the color space is not performed by the color name (e.g., DeviceRGB illustrated in FIG. 8C) (NO in step S902), in step S909, the output value corresponding to the representative color signal value is calculated using the input and output IccProfiles. In step S910, a look-up table is generated and stored as color conversion data in the RAM 603.

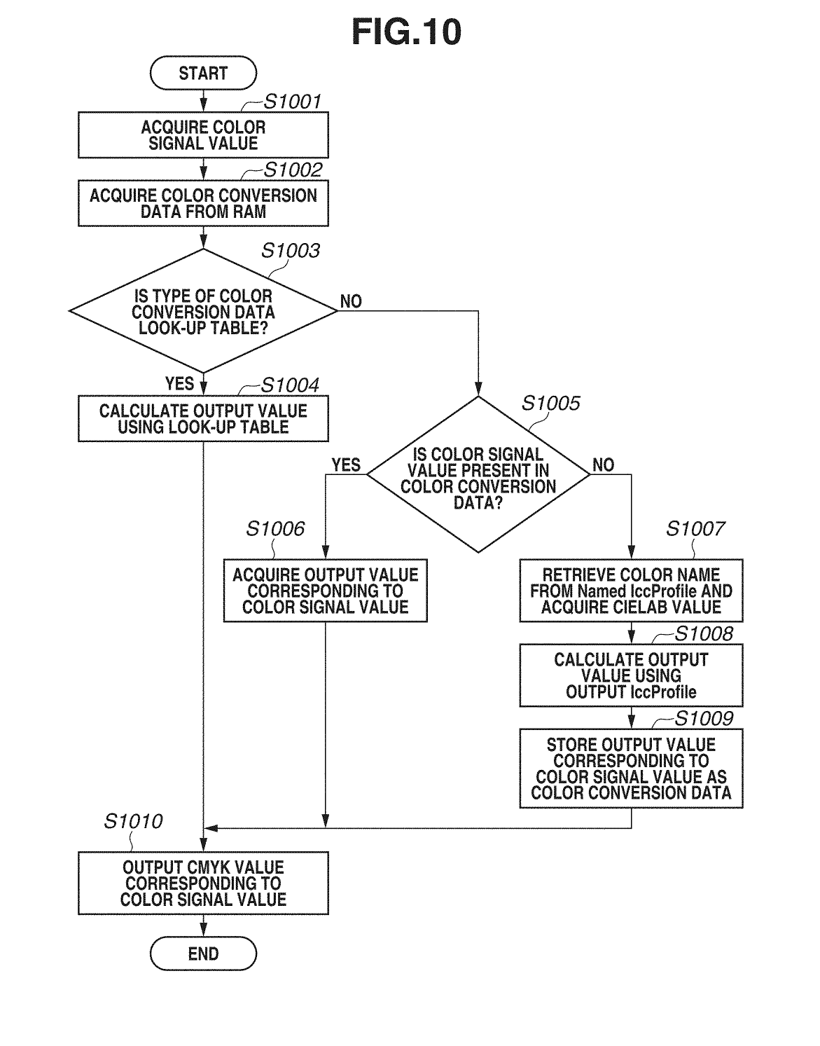

FIG. 10 is a flowchart illustrating processing to be performed by the color conversion unit 708.

In step S1001, the CPU 602 acquires a color signal value from the PDL data interpretation unit 702, and in step S1002, the CPU 602 acquires color conversion data from the RAM 603. In step S1003, the CPU 602 determines whether a type of the color conversion data is a look-up table. If the type of the color conversion data is the look-up table (YES in step S1003), in step S1004, the CPU 602 calculates an output value using the look-up table. If the look-up table includes only the representative color signal values, an output value is calculated by performing an interpolation calculation using the representative color signal values close to the input color signal value. If the type of the color conversion data is not the look-up table (NO in step S1003), in step S1005, it is determined whether the input color signal value stored in the RAM 603 is present in the color conversion data. If the input color signal value is present in the color conversion data (YES in step S1005), in step S1006, an output value corresponding to the color signal value is acquired. If the input color signal value is not present in the color conversion data (NO in step S1005), a corresponding CMYK value is calculated and additionally stored as color conversion data. First, in step S1007, the color name is retrieved from the NamedIccProfile, and a CIELAB value is acquired. Next, in step S1008, an output value is calculated using the output IccProfile. Then, in step S1009, the output value corresponding to the color signal value is stored as color conversion data in the RAM 603. Lastly, in step S1010, the CMYK value corresponding to the color signal value is output to the PDL data interpretation unit 702.

As described above, according to the first exemplary embodiment, in a case where the color space to be processed specified in the PDL uses the spot color as the color name, only the output value corresponding to the color signal value of 100% is calculated. In other words, it is determined that the color conversion is performed only on the color to be processed. Consequently, in a case where the spot color is specified for the color name in the PDL data, it is possible to prevent waste of a processing time and a memory amount required for the color conversion.

In the first exemplary embodiment, in a case where the color name is specified for the color space in the PDL data and where the number of color screens is one, it is considered that the spot color is set to the color name. Accordingly, an output value is calculated using the NamedIccProfile and the output IccProfile each time a new color signal value is specified. Basically, there is no problem with this configuration because only the color signal value of 100% is used for the spot color. However, since a density value other than 100% can also be specified for the color signal value in the PDL, if the density value other than 100% is specified for the color signal value, the amount of calculation of the output value by the method described above is larger than the amount of calculation thereof by the look-up table method.

Accordingly, in a second exemplary embodiment, in a case where it is considered that the spot color is specified for the color name and where the PDL data specifying a density value other than 100% for the color signal value is input, the calculation method is changed so as to generate a look-up table in advance.

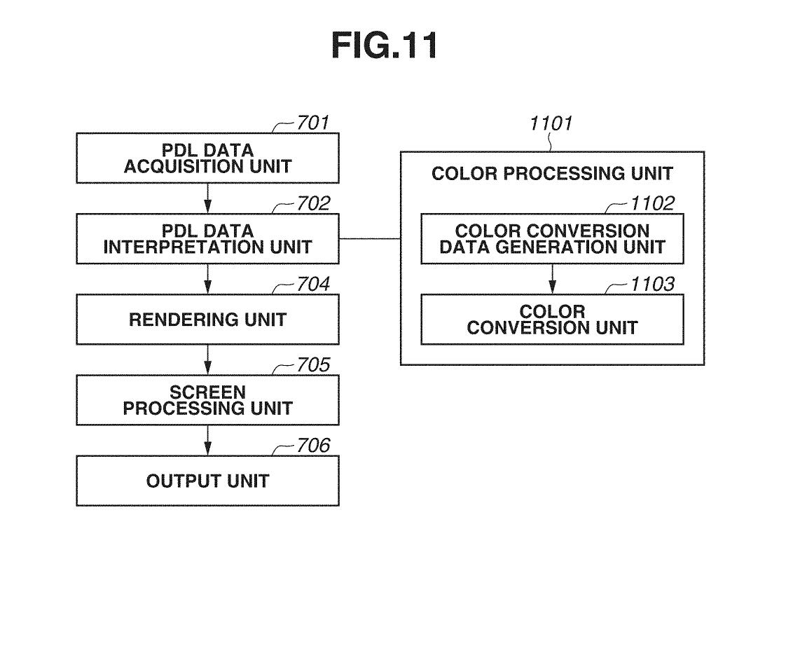

FIG. 11 is a block diagram illustrating an internal configuration of an execution program of a CPU 602 according to the second exemplary embodiment. This program is loaded into the RAM 603 from the ROM 604 and is executed by the CPU 602. The configuration illustrated in FIG. 11 differs from the configuration illustrated in FIG. 7 according to the first exemplary embodiment only with regard to a color processing unit 1101, a color conversion data generation unit 1102, and a color conversion unit 1103. The color processing unit 1101 includes the color conversion data generation unit 1102 and the color conversion unit 1103. The color processing unit 1101 is similar to the color processing unit 703 in that color matching is performed based on the specification of a color space and a color signal value and that the value is converted into density signals of cyan, magenta, yellow, and black (CMYK) of the color material of the printer, and the density signals are output to the PDL data interpretation unit 702.

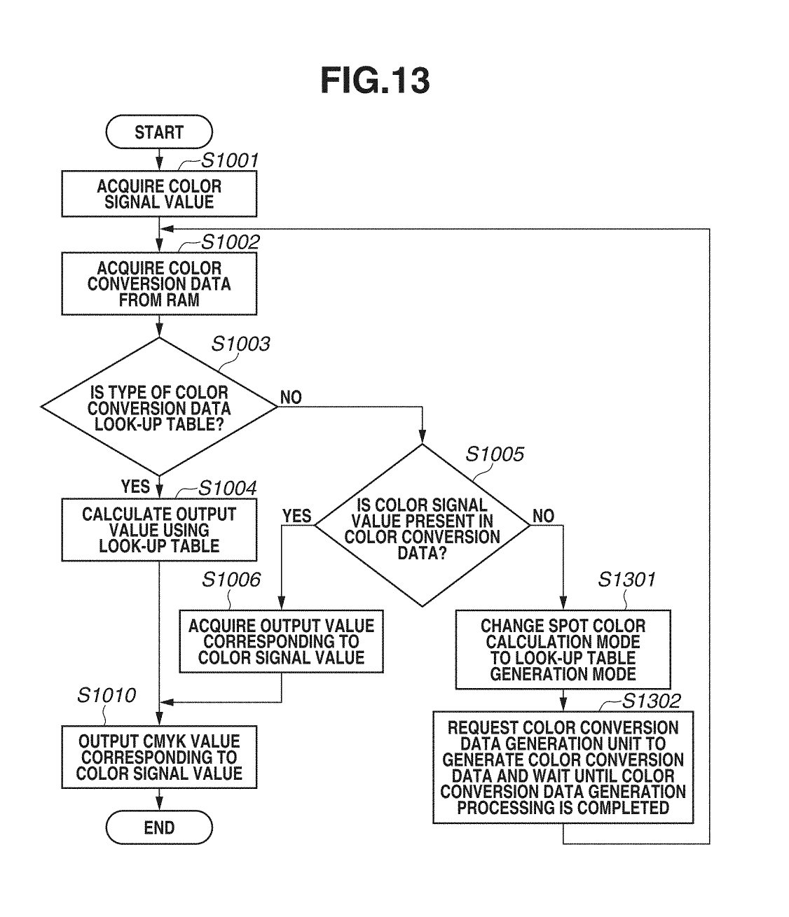

FIG. 13 is a flowchart illustrating processing to be performed by the color conversion unit 1103 according to the second exemplary embodiment. The flowchart of FIG. 13 differs from the flowchart of FIG. 10 according to the first exemplary embodiment only with regard to processing in steps S1301 and S1302. If the color signal value is not present in the color conversion data (NO in step S1005), in step S1301, a spot color calculation mode is changed to a look-up table generation mode. In step S1302, the color conversion unit 1103 requests the color conversion data generation unit 1102 to generate color conversion data and waits until color conversion data generation processing is completed. After the color conversion data generation processing of the color conversion data generation unit 1102 is completed, the processing returns to step S1002 to acquire the color conversion data stored in the RAM 603. In this case, a look-up table can be obtained as the color conversion data, and thus the processing always proceeds to step S1004 after the determination processing in step S1003, and the output value is calculated using the look-up table.

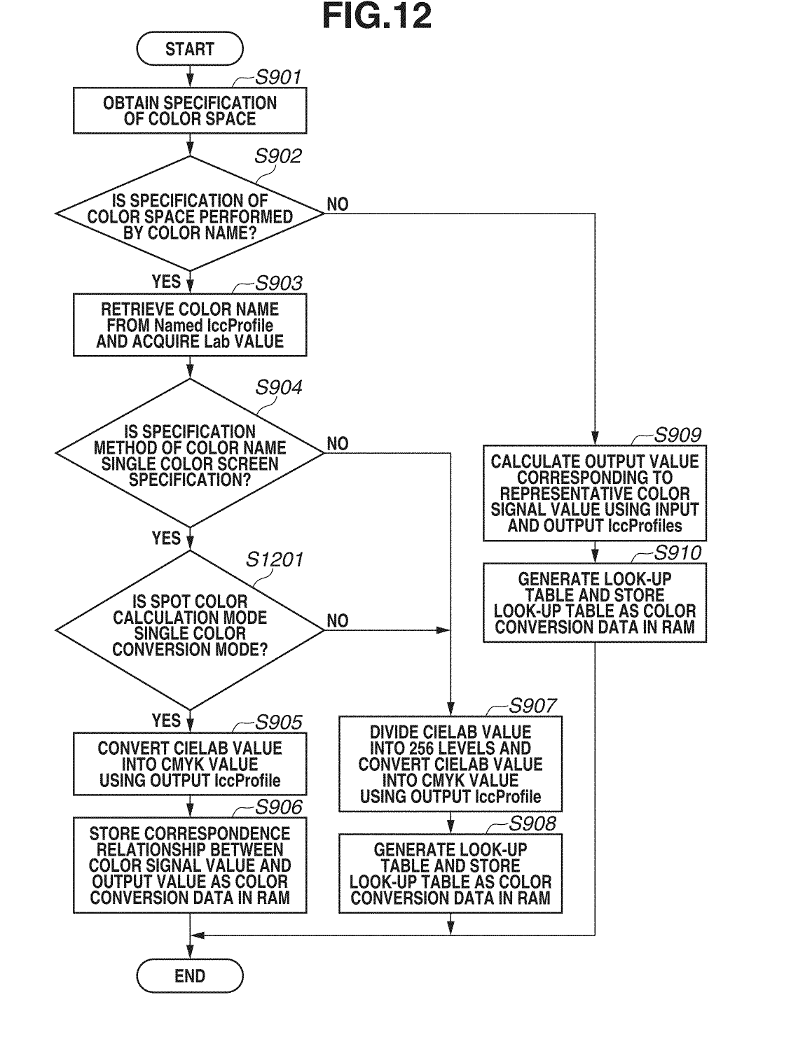

FIG. 12 is a flowchart illustrating processing to be performed by the color conversion data generation unit 1102 according to the second exemplary embodiment. This flowchart differs from the flowchart of FIG. 9 according to the first exemplary embodiment only with regard to processing in step S1201. In step S904, it is determined whether the specification method of the color name is the single color screen specification. If the specification method is the single color screen specification (YES in step S904), in step S1201, it is determined whether the spot color calculation mode is a single color conversion mode. It is assumed that the spot color calculation mode is initialized to the single color conversion mode. Accordingly, the processing normally proceeds to step S905 to perform a single color conversion. However, if the spot color calculation mode is changed to the look-up table generation mode in the flowchart illustrated in FIG. 13, the processing proceeds to step S907 to generate a look-up table.

As described above, according to the second exemplary embodiment, in a case where the density value other than 100% is specified for the color signal value of the spot color, it is possible to prevent a processing time required for the color conversion from increasing compared with that in the look-up table method.

### Other Embodiments

While an electrophotographic apparatus has been described by way of example in the exemplary embodiments, an inkjet printer, a thermal printer, and the like may also be used. The scope of the present disclosure is not limited by a type of the printer. While the exemplary embodiments described above illustrate an example where toner is used as a recording material in electrophotographic printing, the recording material used for printing is not limited to the toner, but instead other recording materials such as ink may also be used. The scope of the present disclosure is not limited by a type of the recording material.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-155447, filed Aug. 10, 2017, which is hereby incorporated by reference herein in its entirety.

What is claimed is:

1. An image processing apparatus comprising:
a memory device that stores a set of instructions; and
at least one processor that executes the set of instructions to:
acquire information about a color space specified for an object to be processed by interpreting input image data; and
determine, by using the acquired information, whether a first color conversion or a second color conversion is used, the first color conversion being used for converting only a color to be processed into a color in a device-dependent color space, the second color conversion being used for converting the color to be processed and the color having a different density into a color in the device-dependent color space.

2. The image processing apparatus according to claim 1, wherein the at least one processor executes instructions in the memory device to determine to perform the first color conversion in a case where a spot color is used as a method for specifying the color space for the color to be processed.

3. The image processing apparatus according to claim 1, wherein the at least one processor executes instructions in the memory device to determine to perform the second color conversion in a case where a special color ink is used as a method for specifying the color space for the color to be processed.

4. The image processing apparatus according to claim 1, wherein the at least one processor executes instructions in the memory device to determine to perform the first color conversion in a case where Separation is used as a method for specifying the color space for the color to be processed.

5. The image processing apparatus according to claim 1, wherein the at least one processor executes instructions in the memory device to determine to perform the second color conversion in a case where DeviceN is used as a method for specifying the color space for the color to be processed.

6. A control method for an image processing apparatus, comprising:
acquiring information about a color space specified for an object to be processed by interpreting input image data; and
determining, by using the acquired information, whether a first color conversion or a second color conversion is used, the first color conversion being used for converting only a color to be processed into a color in a device-dependent color space, the second color conversion being used for converting the color to be processed and the color having a different density into a color in the device-dependent color space.

7. A non-transitory computer-readable storage medium storing a computer program for causing a computer to execute a method of controlling an image processing apparatus, the method comprising:
acquiring information about a color space specified for an object to be processed by interpreting input image data; and
determining, by using the acquired information, whether a first color conversion or a second color conversion is used, the first color conversion being used for converting only a color to be processed into a color in a device-dependent color space, the second color conversion being used for converting the color to be processed and the color having a different density into a color in the device-dependent color space.
